(19) United States
(12) Patent Application Publication
(10) Pub. No.: US 2017/0082035 A1
(43) Pub. Date: Mar. 23, 2017

(54) GAS TURBINE ACTIVE COMBUSTION INSTABILITY CONTROL SYSTEM

(71) Applicant: Moog Inc., East Aurora, NY (US)

(72) Inventor: David Geiger, Orchard Park, NY (US)

(21) Appl. No.: 15/270,115

(22) Filed: Sep. 20, 2016

Related U.S. Application Data
(60) Provisional application No. 62/221,301, filed on Sep. 21, 2015.

(51) Int. Cl. F02C 9/28; F02C 9/26; F02C 3/04; H02K 7/18

(52) U.S. Cl. CPC F02C 9/28; H02K 7/1823; F02C 9/263; F02C 3/04; F05D 2220/76; F05D 2270/301; H02P 2101/25

(57) ABSTRACT

A turbine active combustion instability control system comprising a primary passage to a combustor of a turbine; a combustor pressure sensor configured to measure dynamic pressure within the combustor; a pilot valve metering fuel flow through a pilot passage to the combustor and comprising a valve seat defining a throat in the pilot passage and a valve plug movable to control fuel flow through the throat, the pilot valve having an inlet passage with a contoured surface to accelerate gas flow through the throat to at least Mach 1; a dynamic linear motor actuator connected to the valve plug and configured to actuate the valve plug at a high frequency; and a controller configured to provide a control signal to the actuator as a function of input from the combustor pressure sensor.

### TECHNICAL FIELD

The present invention relates generally to gas turbine combustion chambers and, more particularly, to an improved gas turbine active combustion instability pilot control valve.

### BACKGROUND ART

Combustion turbines generally take in air and compress the air in a compression turbine stage. Gas or oil fuel is metered into a combustion chamber and the resulting hot exhaust gas then passes over the turbine blades creating torque on a shaft. Typically, the shaft is connected to a generator that then produces electricity.

The metering of the fuel in the combustion chamber can be critical because it controls the speed of the turbine as the load varies. For example, when the fuel is metered with high resolution, emissions of environmentally unfriendly gases can be lowered.

Large gas turbines have historically been designed with a combustion chamber optimized for a specific fuel flow rate. However, today's large turbines go through significant flow rate changes during operation, making it difficult to provide a combustion chamber optimized for one flow rate without adversely impacting emissions and efficiency. To address this problem, pressure pulsation caused by the uneven burn of fuel may be sensed with a pressure transducer and an actuation device on a pilot stage fuel supply may be used to modulate pilot fuel at a high frequency rate to counter the effects of the sensed pressure pulsations. This may be referred to as an active combustion control system (ACCS).

U.S. Pat. No. 7,966,801, issued Jun. 28, 2011, and entitled “Apparatus and Method for Gas Turbine Active Combustion Control System,” is directed to an active combustion control system that monitors combustion pressure and modulates fuel to a gas turbine combustor to prevent combustion dynamics and/or flame extinguishments. The system includes an actuator that periodically injects pulsed fuel into the combustor. The actuator is controlled in response to a sensor that generates a signal detecting pressure oscillations in the combustor. The entire contents of U.S. Pat. No. 7,966,801 are incorporated herein by reference.

### BRIEF SUMMARY OF THE INVENTION

With parenthetical reference to corresponding parts, portions or surfaces of the disclosed embodiment, merely for the purposes of illustration and not by way of limitation, a gas turbine active combustion instability control system (15) is provided comprising: a primary fuel flow passage (21) to a combustor (18) of a combustion turbine (58); a combustor pressure sensor (19) configured to measure a dynamic pressure within the combustor; a pilot fuel flow passage (22) to the combustor; a pilot control valve (23) configured to meter fuel flow through the pilot flow passage to the combustor from an upstream side (25) to a downstream side (26), the pilot control valve comprising a pilot metering valve body (28) having a valve seat (29) defining a throat (27) in the pilot flow passage between the upstream side and the downstream side, a pilot metering valve plug (32) movable relative to the pilot metering valve body from an open position to a closed seated position to control fuel flow through the throat from the upstream side to the downstream side, the pilot metering valve body having an inlet passage (30) on the upstream side of the throat, the inlet passage having a contoured surface generally angled to narrow toward the throat and to accelerate gas flow through the throat to at least Mach 1, and the pilot metering valve body having an outlet passage (31) on the downstream side of the throat; a dynamic linear motor actuator (23) connected to the pilot metering valve plug and configured and arranged to actuate the pilot metering valve plug at a high frequency; and a controller (34) configured and arranged to receive input from the combustor pressure sensor and to provide a control signal to the linear motor actuator as a function of the input from the combustor pressure sensor; whereby the pilot control valve assembly is configured to modulate a sonic fuel flow through the throat as a function of the input from the combustor pressure sensor.

### BRIEF DESCRIPTION OF THE DRAWINGS

FIG. 1 is a partial sectional view of a combustion turbine with a first embodiment of an improved active combustion instability control system.

FIG. 2 is an enlarged cross-sectional view of the pilot process valve shown in FIG. 1.

FIG. 3 is an enlarged view of the pilot control valve shown in FIG. 2 in a closed position.

FIG. 4 is an enlarged view of the pilot control valve shown in FIG. 2 in an open position

FIG. 5 is an enlarged view of the pilot actuator shown in FIG. 2.

FIG. 6 is a control electronics flow chart for the actuator controller shown in FIG. 2.

FIG. 7 is a partial perspective cut-away view of a multi-chambered combustion turbine.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

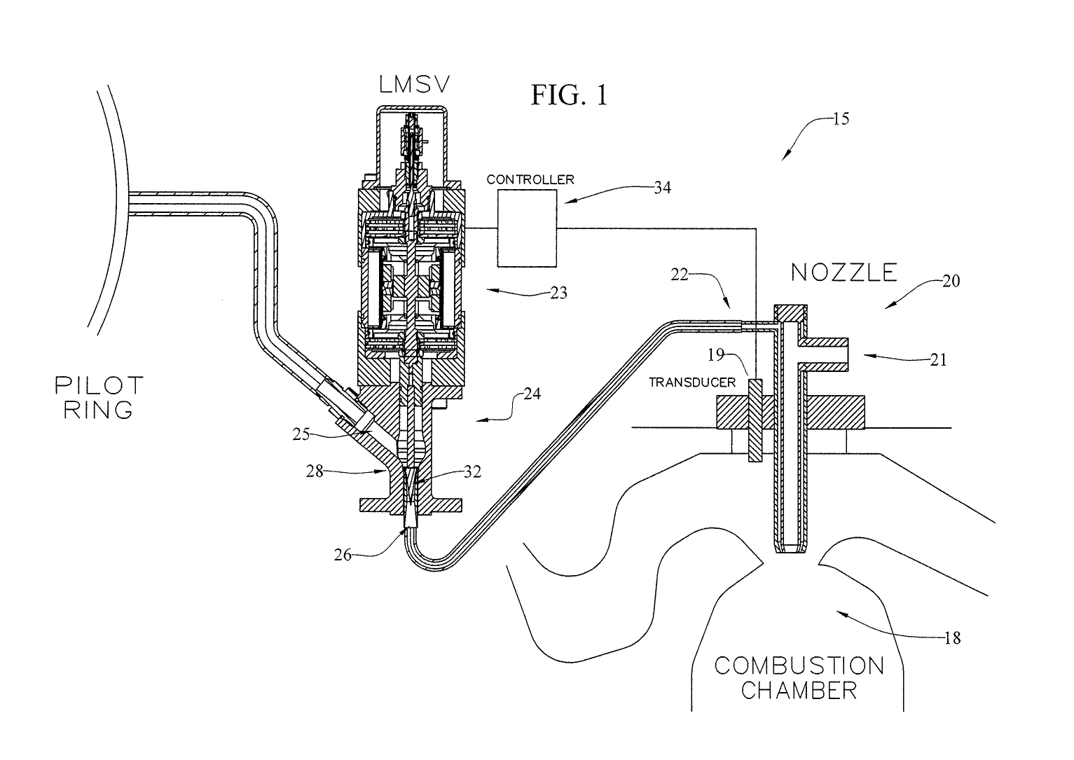

Referring now to the drawings, and more particularly to FIG. 1 thereof, a gas turbine active combustion instability control system is provided, of which an embodiment is generally indicated at 15. In this embodiment, system 15 is employed in a conventional gas turbine 58 having burner nozzle 20 feeding combustion chamber 18. The combustion turbine generally takes air and compresses the air in a compression turbine stage. Gas or oil fuel is metered into combustion chamber 18, resulting in hot exhaust gas passing over the turbine blades of the gas turbine and creating a torque on the shaft of the gas turbine, which in turn powers an electric generator and produces electricity. Burner nozzle 20 has two fuel inputs, conventional primary fuel input 21 and pilot fuel input 22. Both mix at the output stage of nozzle 20. The primary fuel flow rate is controlled with a conventional large fuel control valve which makes low frequency gross flow rate changes. The pilot fuel flow rate is controlled by pilot linear motor sonic valve assembly 17, which makes high frequency small sonic flow rate changes.

As shown, pilot linear motor sonic valve assembly 17 is shown as broadly including high frequency linear actuator 23 and sonic control valve 24, which are configured to meter fuel flow through pilot fuel intake flow passage 22 to nozzle 35 and combustion chamber 18 of combustion turbine 58.

Pilot linear motor sonic valve assembly 17 is provided to meter the fuel flow through fuel intake passage 22. As shown in FIGS. 1-4, sonic control valve 24 is positioned in fuel intake passage 22 and generally comprises stationary valve body 28 and adjustable valve plug 32 to modulate the fuel through throat 27 of valve 24. Metering plug 32 is connected by valve stem 33 and coupling 39 to shaft 38 of linear actuator 23, which modulates the position of metering plug 32 at a high frequency and therefore the flow of fuel through the valve.

Valve body 32 includes inlet passage 30, which narrows to define throat 27, and outlet passage 31. Upstream side 25 of valve 24 is on the upstream side of throat 27 and downstream side 26 of valve 25 is downstream of throat 27. It is understood that the fluid flow is in the direction of arrow 45 such that the fluid flows from inlet passageway 30 out valve outlet passage 31.

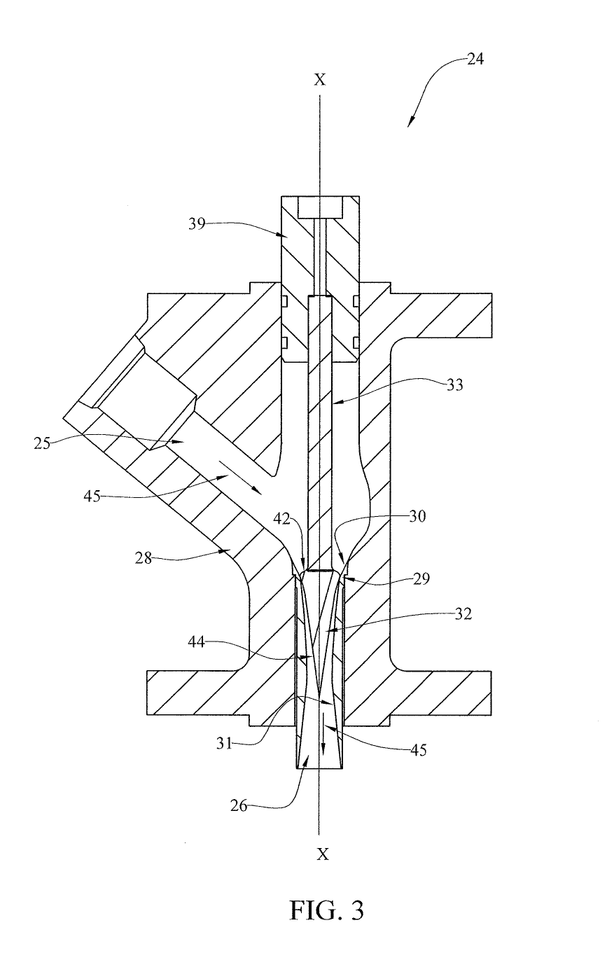

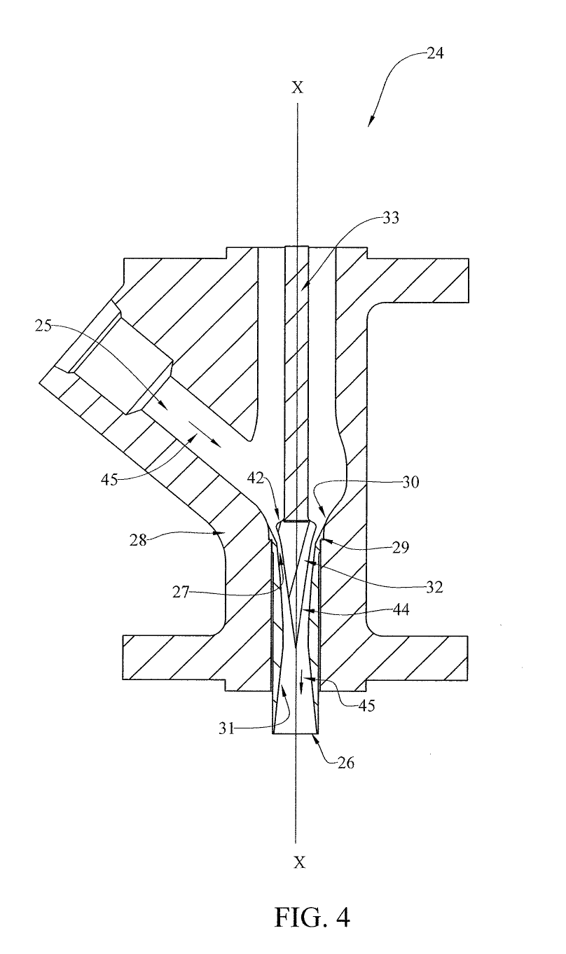

Valve plug 32 is moveable longitudinally along axis x-x between the closed position shown in FIG. 3 and the open position shown in FIG. 4. In the closed position, metering plug 32 is seated against seat 29 of valve body 28 with sufficient force to assure an almost leak free seal. In the open position, metering plug 32 is moved up and away from seat 29 such that the valve flows gas or fluid at a flow rate of at least Mach 1. The modulation of such flow can be controlled by moving valve plug 32 closer or further away from seat 29. In this embodiment, valve seat 29 generally comprises an upwardly and inwardly-facing frusto-conical surface.

As shown in FIGS. 3 and 4, valve plug 32 has a contoured surface that is shaped to provide a desired gas flow versus actuator 23 shaft 38 stroke. Gas inlet passage 30 is tapered and contoured to provide a converging and accelerating flow, with the flow path cross-section area decreasing along the direction of the flow. This converging contoured passage surface 30 is located upstream of nozzle throat 27. Thus, the surfaces of passage 30 narrow and accelerate the gas flow upstream of plug seat 29 and throat 27. The upper, angled passageway 30 is formed by downwardly converging seat surfaces generally in the shape of a cone or funnel. In this embodiment, throat 27 generally occurs at the minimum cross-sectional area between plug 32 and valve body 28. The shaping of the converging contoured surface is such that the area gradient continues to become more and more negative closer to nozzle throat 27. The area gradient is the rate of change of the cross-sectional area per linear unit (e.g., inch) of axial distance along the flow direction 45.

As shown in FIGS. 3 and 4, outlet passage 31 is tapered and contoured to provide a diverging and decelerating flow, with the flow path cross-section area increasing along the direction of the flow 45. This contoured passage surface 31 is located downstream of nozzle throat 27. Thus, valve body 28 has an upper inwardly converging angled portion 30, and a lower outwardly diverging passageway 31.

Elongated contoured plug 32 is provided for engaging seat 29 within upper angled passage 30 to control or modulate the fluid flow. In this embodiment, the top or upstream side of valve plug 32 has an upwardly and outwardly-facing domed surface 42 joined at its upper inner annular edge to valve stem 33. The bottom or downstream side of valve plug 33 generally comprises an outwardly and downwardly-facing frusto-conical surface ending at a downstream point and joined at its upper annular marginal edge to the lower annular marginal edge of domed surface 42. Thus, plug 32 has a curved tapered upstream surface 42 in which the diameter of plug 32 increases in the direction of flow, and has a conical downstream surface 44 in which the diameter of plug 32 decreases in the direction of flow.

Plug is connected to or may be formed integrally with valve stem 33. Valve stem 33 is connected via coupling 39 to output shaft 38 of linear actuator 23. Valve stem 33 may thereby be suitably stroked by linear actuator 23 to position plug 32 into and away from a fluid sealing position within valve throat 27 for controlling the fluid flow through valve 17. Actuator 23 is coupled to valve stem 33 and configured to move valve plug 32 in response to control signals from controller 34 and linear variable differential transformer (LVDT) 56.

With such a configuration, valve 24 exhibits a desired very low pressure drop ratio factor. The critical pressure ratio (P1/P2) for a valve is defined as the ratio of inlet pressure (P1) to outlet pressure (P2) where the valve flow rate drops below some percentage of the sonic flow rate. Sonic gas flow valve 24 has a velocity in throat 27 (narrowest section) of at least Mach 1.0.When the gas velocity is at least Mach 1.0 in throat 27, flow through throat 27 is not dependent on upstream pressure.

Thus, linear motor sonic valve flow valve assembly 27 is optimized to deliver sonic flow at extremely low pressure drops. Valve 24 utilizes stationary metering body 28 and adjustable metering plug 32 to meter the fuel through the valve. The geometry of plug 32 and body 28 is such that it accelerates the flow prior to chock point 27 such that chock metering point 27 has gas flow which is sonic speed. The valve body and plug geometry delivers both high Cg through put flow and low pressure drop across the valve at a sonic speed at metering chock point 27. This allows the flow at a given valve stroke to remain relatively constant independent of the upstream pressure. The algorithms used to cancel combustion chamber 18 pulsations rely on high frequency valve movements. Valve 24 is advantageous because, at each of the valve stroke positions, flow is repeatable regardless of the upstream pressure. If a non-sonic valve were used, then an additional downstream fuel flow sensor would need to be added into the control scheme.

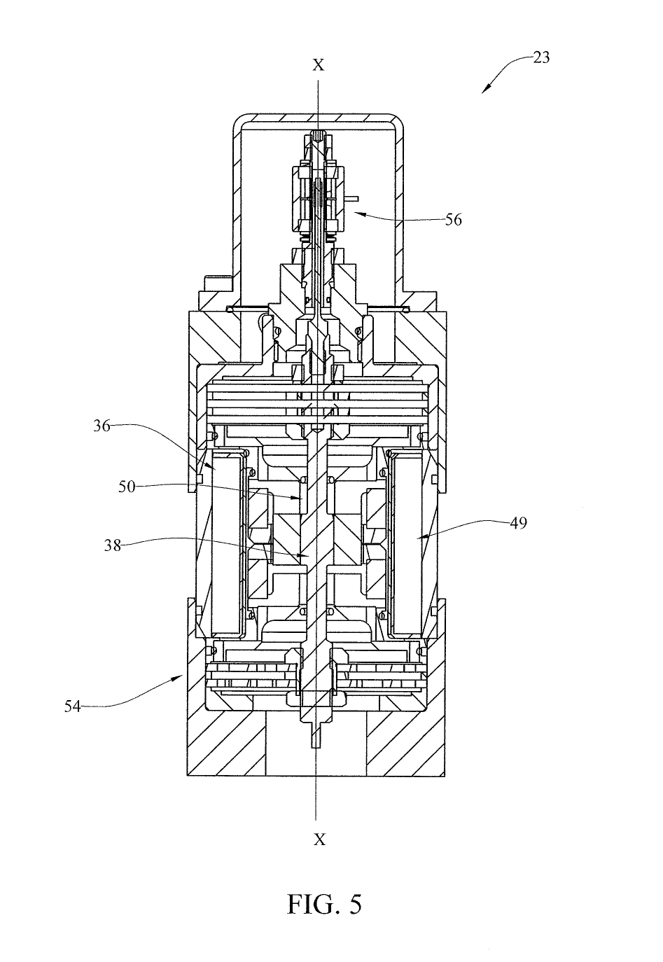

Actuator 23 controls the movement of valve plug 32 relative to nozzle 28. Actuator 23 is a linear magnetic motor actuator configured to actuate plug 32 in valve body 28 between the open and closed positions. As shown in FIG. 5, in this embodiment linear magnetic motor 23 is a three-phase permanent magnet linear DC electric motor having stationary stator 36, sliding shaft 38 and position transducer or LVDT 56 for measuring the linear displacement and position of shaft 38. Shaft 38 is driven to move linearly (that is, as a straight line translation) with respect to stator assembly 36. Stator 36 is a generally hollow cylindrical member elongated about axis x-x and having inner cylindrical passage 50. Shaft 38 is a generally cylindrical member coincident with stator 36 and moves linearly along axis x-x through passage 50 relative to stator 36. Movement along axis x-x is referred to herein as movement in the axial direction. Shaft 38 is at least partially surrounded by stator 36 and is held in place relative to stator assembly 36 by bearings.

Shaft 38 is a specially configured cylindrical member comprising permanent magnets. Shaft 38 generates magnetic fields by virtue of having a series of built in permanent magnets and stator 36 generates magnetic fields through a series of annular magnetic coils 49. By timing the flow of current in coils 49 with respect to the position or momentum of shaft 38, the interaction of magnetic forces from shaft 38 and stator 36 will actuate shaft 36 to move. Thus, linear motor 23 uses both the constant magnetic force generated by a plurality of permanent magnets and the controllable magnetic flux generated through the use of electromagnetic coils 49 to produce motion of shaft 38 relative to stator 36.

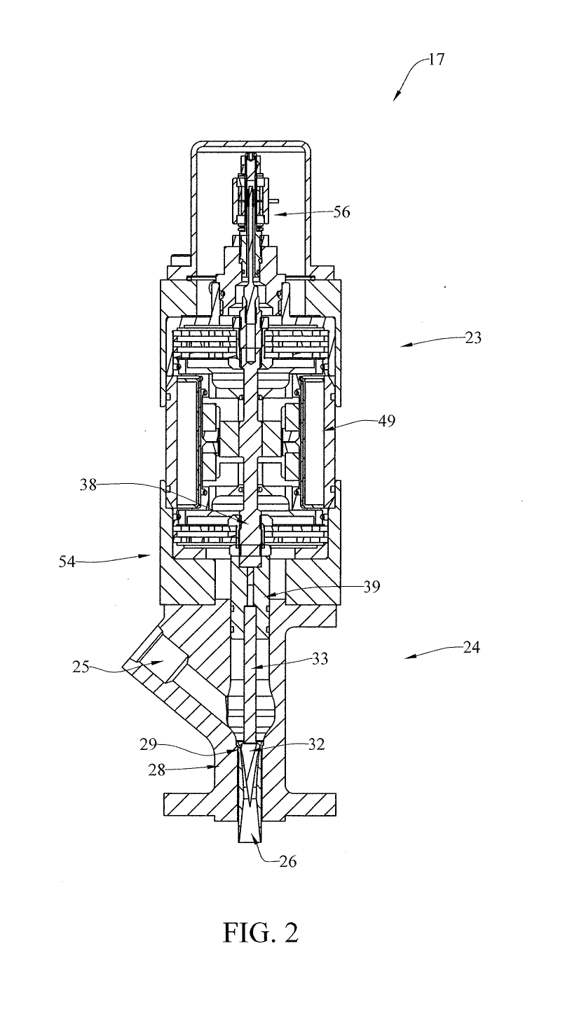

Stator 36 and shaft 38 are disposed in cylindrical housing 54. Stator 36 does not move axially relative to housing 54. As shown in FIG. 2, actuator housing 54 is fixed to valve body 28. Shaft 38 is connected to plug stem 33 by coupling 39, which provides guidance and seals actuator 23 from passage 30. Power supplied to linear actuator 23 generates a magnetic field within coils 49 of stator 36, which in turn imparts an oscillating force on magnetic shaft 38 and connector 39. Shaft 38 and connector 39 are thereby translated linearly relative to stator 38, which thus imparts linear movement to plug stem 33 and plug 32 relative to valve body 28. Thus, linear magnetic motor 23 has a series of windings 49 that act upon inner shaft 38 connected to plug stem 33. Power supplied to motor 23 generates a magnetic field within coils 49 which, in turn, imparts an oscillating force on shaft 38. Shaft 39 thereby is translated in a linear fashion within housing 54. Shaft 38 is connected, through linkage 39, to stem 33 of plug 32 and thus imparts translational or lineal movement to plug 32. Linear electric motor 23 thus enables plug 32 of valve 24 to reciprocate. Actuator 23 provides high frequency linear movement. In this embodiment, such frequency is 100 Hz or greater, and preferably over 1 kHz.

In this embodiment, pressure sensor 19 is a piezoelectric pressure transducer which provides an output signal to controller 34. Thus, transducer 19 may be used to measure pressure oscillations in combustion chamber 18 caused by combustion instability. However, other types of pressure sensors or combustion diagnostic sensors may be used as alternatives. For example, and without limitation, a heat release sensor, an emissions sensor and/or a fuel to air ratio sensor may be used.

Controller 34 is programmed to control motor 23 and modulate plug 32 as a function of dynamic pressure measurements taken by pressure transducer 19. In general, pressure transducer 19 measures the pressure oscillations in combustion chamber 18. This signal is used by controller 34 to derive an input signal for actuator 23 which modulates plug 32 and the fuel flow through valve 24. The resulting flow rate oscillation affects the heat release rate in the combustion zone opposite to the oscillation of the heat release rate caused by the self-excitation process. Modulating the pilot fuel flow rate influences the heat release of the main flame accordingly. Thus, linear motor sonic valve 17 counteracts the combustion oscillations.

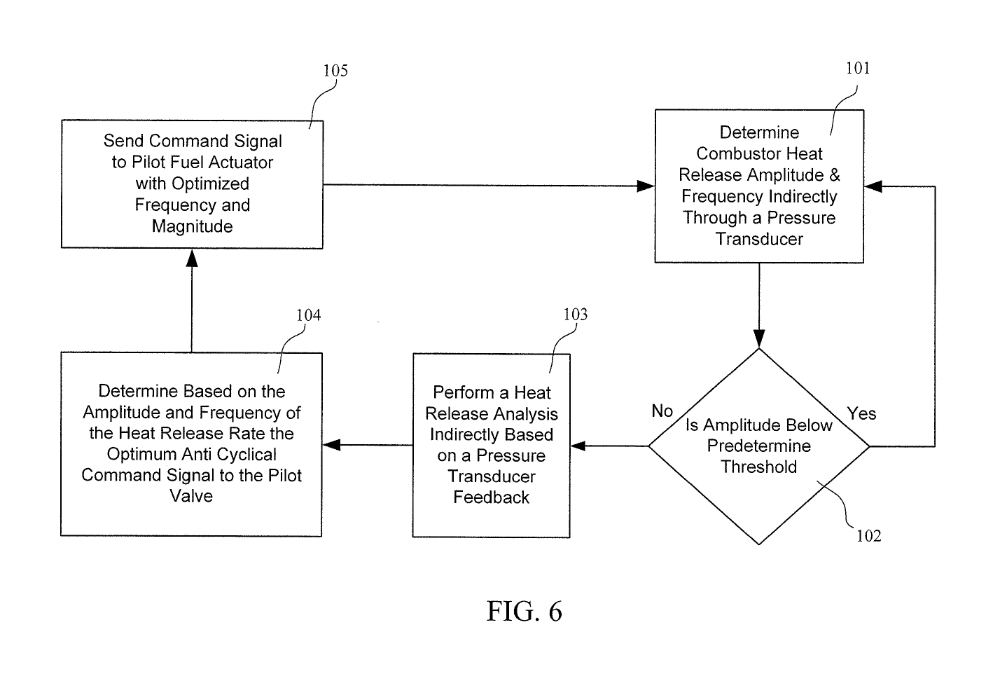

As shown in FIG. 6, pressure transducer 19 is connected to controller 34 and measurements from pressure transducer 19 are periodically conveyed to controller 34. Controller 34 is programmed to determine combustor heat release amplitude and frequency from readings by pressure transducer 19. If such amplitude is below a determined threshold 102, controller 34 continues to monitor and determine combustor heat release amplitude and frequency. If such amplitude is not below a predetermined threshold, controller 34 performs a heat release analysis 103 based on pressure transducer 19 feedback. Controller 34 then determines 104 the optimal anti-cyclical command signal for pilot valve 24 based on the amplitude and frequency of the heat release rate. Controller 34 sends a command signal to actuator 23 with the optimized frequency and magnitude 105. The process then continues to repeat itself. Thus, an output signal is provided by controller 34 to actuator 23 based on the pressure sensor signal from transducer 19 in combustor 18 so that the induced modulation of the heat release rate is anti-cyclical to the self-excited heat release oscillation in combustor 18.

Controller 34 may be programmed to adjust the valve flow rate to meet a predetermined engine performance requirement. Controller 34 may also be programmed to adjust the valve flow rate in real time. Transducer 19 is connected to combustion chamber 18 downstream and generates a signal amplitude and frequency based on pressure oscillations in combustor 18. Thus, controller 34 performs a real-time analysis of the dynamic pressure measured by combustor pressure sensor 19 and determines the frequency and amplitude required by actuator 23 and valve 24 to create a heat release rate which is anti-cyclical to the self-excited heat release oscillation. In this manner, pressure pulsation caused by uneven burn of fuel are measured by piezoelectric pressure transducer 19 and high frequency linear actuator 23 is controlled to modulate the pilot fuel at a high frequency rate to counter the effects of the pressure pulsation.

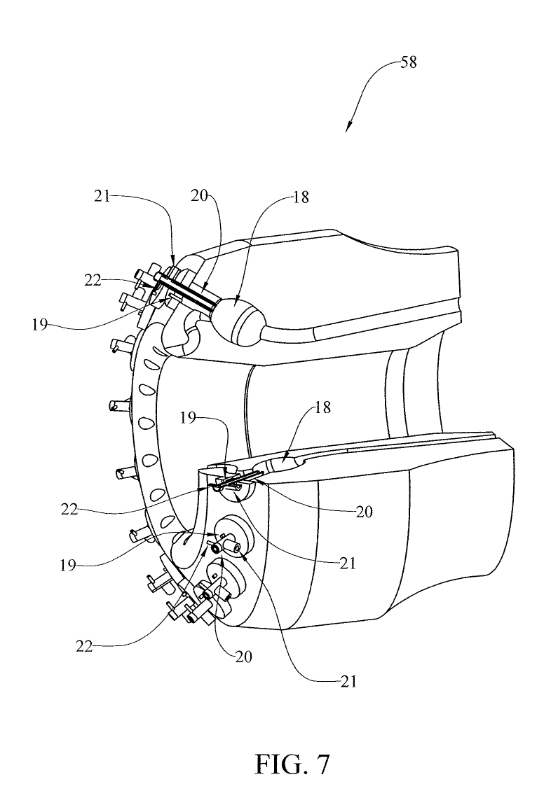

As shown in FIG. 7, conventional gas turbine 58 has multiple combustion chambers (severally indicated at 18) and burners (severally indicated at 20), with primary and pilot fuel inputs (severally indicated at 21 and 22, respectively) to each. Each of such burners and chambers may be equipped with a separate linear motor sonic valve 17 together with a corresponding pressure sensor (severally indicated at 19) and feedback loops. This assures that the induced modulation of the heat release rate is anti-cyclical to the self-excited heat release oscillations at each combustion chamber.

Other types of actuator may be used as alternatives to linear actuator 23. For example, a rotary electro-mechanical actuator configured to actuate plug 32 may be used. In this embodiment, an electric motor having a stator and a rotor is connected through a rotary to linear mechanical converter to stem 33 and plug 32. For example, the electric motor may be mechanically connected to rotate a shaft that has continuous helical threads machined on its circumference running along its length. A ball nut with corresponding helical threads may be threaded onto the rotary shaft and prevented from rotating with the shaft such that, when the shaft is rotated, the nut is driven along the threads of the shaft. The direction of motion of the ball nut depends on the direction of rotation of the shaft and therefor the directional rotation of the rotor of the motor. The top of stem 33 is attached to the ball nut, such that rotational motion of the motor can be converted to linear displacement of valve plug 32.

As another alternate embodiment, an electro-hydrostatic actuator (EHA) may be used. An EHA is a fully self-contained actuation system that receives power from an electrical source and transforms an input command (usually electrical) into motion. It includes a servo-motor, a hydraulic pump, a reservoir and/or accumulator, and a servo-motor. In this embodiment, a servo-motor is used to drive the reversible pump. The pump pressurizes a working fluid, typically hydraulic oil, directly raising the pressure in a hydraulic gap on one side or the other of a tab, which causes stem 33 to move up or down as desired. The entire system comprises the pump, the servo-motor and a reservoir of hydraulic fluid, which is packaged into a single self-contained unit. Instead of energy needed to move the controls being supplied by an external hydraulic supply, it is supplied over normal electrical wiring. The EHA draws power when it is being moved, but pressure is maintained internally when the motor stops.

As another alternative, an electro-hydraulic actuator (EH) may be used to control movement of stem 33 and plug 32. The electro-hydraulic actuator generally comprises control electronics which create a command input signal, a servo-amplifier which provides a low power electrical actuating signal that is the difference between the command input signal and a feed-back signal generated by a feed-back transducer, a servo valve which responds to this low power electrical signal and controls the flow of hydraulic fluid to stem 33 to position plug 32, and a power supply, generally an electrical motor and a pump, which provides the flow of a hydraulic fluid under high pressure. The feed-back transducer measures the output position of the actuator and converts this measurement into a proportional signal which is sent back to the servo-amplifier.

As another alternative, the actuator may be a conventional hydraulic actuator. With a hydraulic actuator, an unbalanced pressure applied to valve stem 33 generates the force to move valve stem 33 and plug 32 between the open and closed position.

The present disclosure contemplates that many changes and modifications may be made. Therefore, while an embodiment of the improved gas turbine active combustion instability control system has been shown and described, and a number of alternatives discussed, persons skilled in this art will readily appreciate that various additional changes and modifications may be made without departing from the scope of the invention, as defined and differentiated by the following claims.

What is claimed is:

1. A gas turbine active combustion instability control system comprising:
a primary fuel flow passage to a combustor of a combustion turbine;
a combustor pressure sensor configured to measure a dynamic pressure within said combustor;
a pilot fuel flow passage to said combustor;
a pilot control valve configured to meter fuel flow through said pilot flow passage to said combustor from an upstream side to a downstream side, said pilot control valve comprising:
a pilot metering valve body having a valve seat defining a throat in said pilot flow passage between said upstream side and said downstream side;
a pilot metering valve plug movable relative to said pilot metering valve body from an open position to a closed seated position to control fuel flow through said throat from said upstream side to said downstream side;
said pilot metering valve body having an inlet passage on said upstream side of said throat, said inlet passage having a contoured surface generally angled to narrow toward said throat and to accelerate gas flow through said throat to at least Mach 1;
said pilot metering valve body having an outlet passage on said downstream side of said throat;
a dynamic linear motor actuator connected to said pilot metering valve plug and configured and arranged to actuate said pilot metering valve plug at a high frequency; and
a controller configured and arranged to receive input from said combustor pressure sensor and to provide a control signal to said linear motor actuator as a function of said input from said combustor pressure sensor;
whereby said pilot control valve assembly is configured and arranged to modulate a sonic fuel flow through said throat as a function of said input from said combustor pressure sensor.

2. The gas turbine active combustion instability control system set forth in claim 1, wherein said inlet passage comprises a frusto-conical surface.

3. The gas turbine active combustion instability control system set forth in claim 1, wherein said actuator comprises a stator and a shaft connected to said pilot metering valve plug for actuating said pilot metering valve plug between said closed position and said open position.

4. The gas turbine active combustion instability control system set forth in claim 1, wherein said combustion turbine powers an electric generator.

5. The gas turbine active combustion instability control system set forth in claim 1, wherein said controller is located in said linear motor actuator.

6. A gas turbine active combustion instability control system comprising:
a primary fuel flow passage to a combustor of a combustion turbine;
a combustor diagnostic sensor configured to measure combustion parameters within said combustor;
a pilot fuel flow passage to said combustor;
a pilot control valve configured to meter fuel flow through said pilot flow passage to said combustor from an upstream side to a downstream side, said pilot control valve comprising:
a pilot metering valve body having a valve seat defining a throat in said pilot flow passage between said upstream side and said downstream side;
a pilot metering valve plug movable relative to said pilot metering valve body from an open position to a closed seated position to control fuel flow through said throat from said upstream side to said downstream side;
said pilot metering valve body having an inlet passage on said upstream side of said throat, said inlet passage having a contoured surface generally angled to narrow toward said throat and to accelerate gas flow through said throat to at least Mach 1;
said pilot metering valve body having an outlet passage on said downstream side of said throat;
an actuator connected to said pilot metering valve plug and configured and arranged to actuate said pilot metering valve plug at a high frequency; and
a controller configured and arranged to receive input from said combustor diagnostic sensor and to provide a control signal to said actuator as a function of said input from said combustor diagnostic sensor;
whereby said pilot control valve assembly is configured and arranged to modulate a sonic fuel flow through said throat as a function of said input from said combustor pressure sensor

7. The gas turbine active combustion instability control system set forth in claim 6, wherein said actuator is selected from a group consisting of a linear actuator, a rotary actuator, an electro-hydrostatic actuator, an electrohydraulic linear actuator and a hydraulic linear actuator.

8. The gas turbine active combustion instability control system set forth in claim 6, wherein said combustor diagnostic sensor comprises a dynamic pressure sensor.
